(19) United States
(12) Patent Application Publication
(10) Pub. No.: US 2006/0202835 A1
(43) Pub. Date: Sep. 14, 2006

(54) Dual frequency identification device

(75) Inventor: Ronald M. Thibault, Osborne, KS (US)

Correspondence Address: THOMPSON & THOMPSON, P.A., P.O BOX 166, SCANDIA, KS, 66966, US

(73) Assignee: Osborne Industries, Inc.

(21) Appl. No.: 11/361,862

(22) Filed: Feb. 23, 2006

Related U.S. Application Data
(60) Provisional application No. 60/656,627, filed on Feb. 25, 2005.

(51) Int. Cl. G08B 23/00; G08B 13/14

(52) U.S. Cl. 340/573.1; 340/572.8; 340/572.9

(57) ABSTRACT

A dual frequency identification system for animals is contained within an ear tag structure adapted to be attached to an animal's ear. The system includes a first radio frequency component having a first antenna that operates at a first frequency, and a second radio frequency component having a second antenna that operates at a second frequency higher than the first frequency. The radio frequency identification system is programmed to transmit the same identification code from both of the first and second antennas, whereby the tag can be interrogated by reader antennas operating at different frequencies to identify the same animal. Various constructions for the ear tag are disclosed in which the first and second frequency components are molded into the plastic parts of the ear tag.

### RELATED APPLICATIONS

This application claims priority of U.S. Provisional Application Ser. No. 60/656,627 filed on Feb. 25, 2005.

### FIELD OF THE INVENTION

The present invention relates generally to radio frequency identification (RFID) devices, and in particular, to RFID devices that can be used to identify, track and/or manage animals in the livestock industry and various other fields of use. The present invention will be described in connection with its use in the livestock industry, particularly with cattle, but it should be understood that its utility is not limited to livestock or any other particular field of use.

### BACKGROUND OF THE INVENTION

The use of RFID devices to identify, track and manage cattle has become increasingly important in recent years as a means for controlling spread of disease, for insuring food safety, and for rewarding producers for the production of quality meat products. To facilitate international trade, ISO standards for RFID have been proposed and, although not accepted internationally yet, appear to be gaining influence in the market in the absence of any competing alternative.

RFID ear tags that use the ISO standard frequency of 134.2 kHz are used effectively for many applications (e.g., pigs), however these RFID ear tags do not solve problems for use with cattle.

The read range for ISO ear tags is generally too short for many applications. For example, cattle must move in single file past a reader to ensure that their ear tags can be read. This is impractical for many circumstances where large groups of cattle must be moved rapidly. Usually alleyways between cattle pens are designed to allow five or more cattle to move adjacent to each other from pen to pen or from pen to sale ring. Inserting multiple single-file antennas and readers into such a situation is not practical. Similarly, many cattle usually eat at a feed bunk simultaneously. Identifying individual animals with ISO ear tags requires multiple antennas, a means of separating animals to prevent interference between multiple antennas, and the use of a multiplexing reader. Use of the ISO ear tags and associated technology is unacceptable in many similar circumstances because it slows the “speed of commerce” for the producer.

It is well known that higher frequency RFID technologies offer certain advantages over the ISO standard frequency that are desirable, including lower cost of production, longer read range, and reading speed that enables the use of anti-collision techniques so that large numbers of RFID numbers can be read in an assembly, using only one reader/antenna combination. However, these higher frequency RFID technologies do not penetrate materials very well, and tend to bounce off objects or become absorbed by water or body tissue. Because of these deficiencies, the higher frequency RFID technologies were not adopted as the ISO standard for livestock identification.

There is a need in the industry for an improved RFID system that solves the problems with the existing RFID systems described above.

### SUMMARY OF THE INVENTION

It is an object of the present invention to provide an improved RFID system that overcomes the problems in the prior art systems described above.

It is a further object of the present invention to provide an RFID system that can be used effectively in a wide variety of conditions, has a low cost of production, is reliable and durable, has a relatively long reading range, can be used in a manner which does not slow the speed of commerce, and incorporates the ISO frequency standard for the target industry.

The present invention provides an RFID system that incorporates two different frequency transmitters on the same tag for transmitting a unique identification code from the tag to readers operating at different frequencies. The RFID system can be contained, for example, within an ear tag structure adapted to be attached to an animal's ear. The RFID system includes a first radio frequency component having a first antenna that transmits at a first frequency, and a second radio frequency component having a second antenna that transmits at a second frequency higher than the first frequency. The RFID system is programmed to transmit the same identification code from both of the first and second antennas, whereby the tag can be interrogated by reader antennas operating at different frequencies to identify the same animal. Various embodiments for the ear tag structure are also disclosed herein.

According to a broad aspect of the present invention, an identification system for animals is provided, comprising: a structure for attaching the identification system to a body part of an animal; a first radio frequency identification component having a first antenna operating at a first frequency; a second radio frequency identification component having a second antenna operating at a second frequency, the second frequency being higher than the first frequency; and a means for transmitting an identification code from both of the first and second antennas for allowing the identification code to be read by readers operating at different frequencies to identify the same animal.

According to another broad aspect of the present invention, a dual frequency identification system is provided, comprising: a first radio frequency identification component having a first antenna operating at a first frequency; a second radio frequency identification component having a second antenna operating at a second frequency, the second frequency being at least an order of magnitude different from the first frequency; and a programmable microchip associated with the first and second components for storing and transmitting an identification code from both of the first and second antennas so that the identification code can be read by readers operating at different frequencies.

According to another broad aspect of the present invention, a method of marking and identifying animals is provided, comprising the steps of: providing a tag having a radio frequency identification system with first and second antennas operating at different frequencies, and an identification code programmed into the system that can be transmitted from the first and second antennas; attaching the tag to a body part of an animal; and using a first reader to read the identification code transmitted from the first antenna. A second reader operating at a different frequency than the first reader can be used to read the identification code transmitted from the second antenna.

Numerous other objects and features of the present invention will be apparent to those skilled in this art from the following description wherein there is shown and described exemplary embodiments of the present invention, simply by way of illustration of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective front view of a dual frequency ear tag according to a first embodiment of the present invention.

FIG. 2 is a perspective rear view of the ear tag shown in FIG. 1.

FIG. 3 is a perspective front view of a dual frequency ear tag according to a second embodiment of the present invention.

FIG. 4 is a perspective rear view of the ear tag shown in FIG. 2.

### DETAILED DESCRIPTION OF THE INVENTION

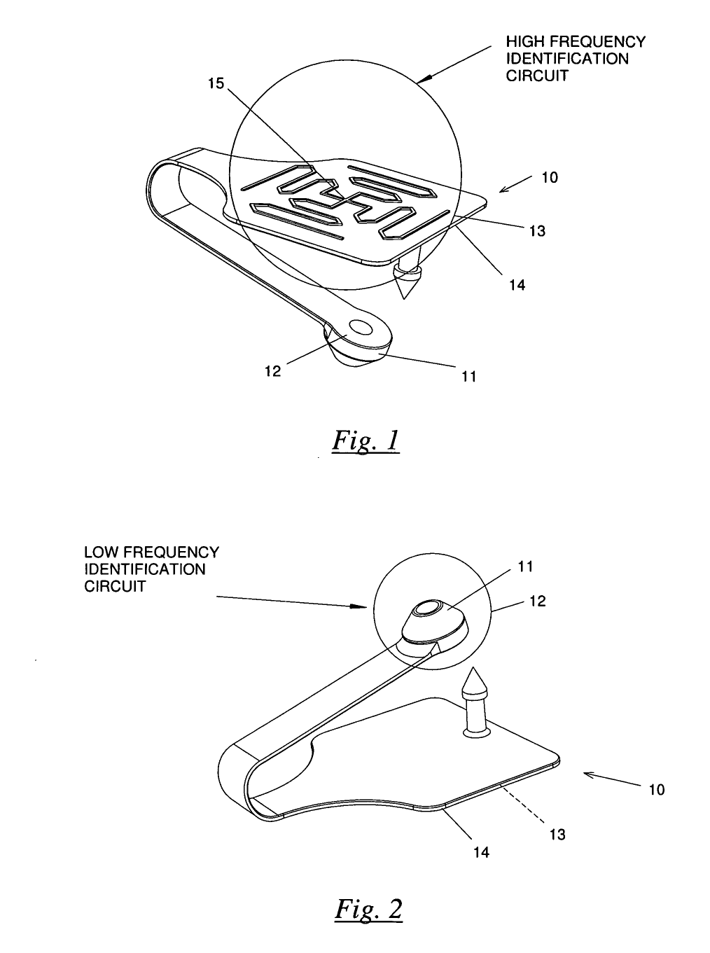

A radio frequency identification device (RFID) according to the present invention will now be described with reference to FIGS. 1 to 4 of the accompanying drawings.

The present invention incorporates into one RFID tag both (1) the ISO standard 134.2 kHz RFID technology, and (2) a higher frequency technology, for example 13.56 Mhz, 868-915 Mhz, or 2.45/5.8 GHz. The dual frequency tag can incorporate two antennas, optimized for each frequency, and a microchip to operate at each frequency. The unique ISO code would be programmed into both microchips if two microchips are used. Alternatively, a new “dual-channel” microchip can be made to operate at two frequencies, utilizing shared or parallel components, to reduce cost for dual frequency tags.

The dual frequency tag of the present invention can use either an active or a passive RFID system, or a combination of active and passive systems. For example, the low frequency component of the tag can be a passive system, while the high frequency component of the tag can be an active system. Passive systems are those that have no power source other than the transmitter, which is normally charged by a reader through the antenna. Active systems are those that have their own power source (usually a battery) and a transmitter. Both passive and active RFID systems are known in the art, and therefore the circuit details of such systems will not be explained in great detail herein. While active RFID systems can be made to have a longer read range, passive RFID systems have other advantages that may make them more suitable for a given application. For example, passive RFID systems will generally have a lower cost, less susceptibility to interference from external conditions (e.g., rain storms), longer operating life, and less maintenance.

The two antennas and one or two RFID microchips can be molded into a single plastic ear tag device. The cost of the extra high frequency antenna and microchip is small compared to the cost of the low frequency ISO coil and microchip. Both are small compared to the cost of over-molding the RFID components into a functional ear tag. Therefore, adding a high frequency component to the ISO standard components should not greatly increase the cost of the RFID ear tag device, while greatly extending its utility by overcoming its current deficits.

FIGS. 1 and 2 of the drawings show a dual frequency tag 10 according to a first embodiment of the present invention. The tag 10 according to this embodiment has a one-piece construction with a low-frequency (LF) RFID circuit 11 (e.g., operating at 134.2 Khz) molded into the female part 12 of the livestock tag 10. The high frequency (HF) RFID circuit 13 (e.g., operating at 915 Mhz) is embedded below the surface of the “flag” or male part 14 of the tag 10. The HF RFID circuit 13 is shown schematically in FIG. 1 as radiating from a central transponder chip 15, but various other suitable circuits will be known to those skilled in the art. In normal practice, the HF RFID circuit 13 will not be visible and would be over-molded by a layer of plastic to shield the circuit components from wear and the elements. The exposed face of the flag part 14 of the tag 10 could also be engraved or marked with visible numbers or other indicia commonly used in the livestock industry for visual identification.

A special tool (not shown) will accept the one piece construction of the tag 10 shown in FIGS. 1 and 2 and apply it as a single piece to the ear of an animal, such that the LF RFID part 11 would be within the ear and the HF RFID part 13 would be on the outside of the ear. This construction provides several advantages, including the following.

First, the construction of the tag 10 ensures that the LF and HF RFID are simultaneously applied so that the common RFID number or identification code that they are preprogrammed to transmit when interrogated by a reading antenna is on the same animal. This ensures that two different numbers will not be carried by one tag assembly on the same animal. Loss or removal of the tag 10 ensures that either both LF and HF RFID are lost or, if removed, that the tag 10 is destroyed and cannot be reapplied to another animal.

Second, this construction presents the HF RFID on the flag part 14 in the best orientation outside the body mass of the animal's ear so that it can be optimally read (i.e., HF-RF energy is absorbed and signal strength is dampened by water and water-containing bodies like the flesh of the ear, while LF-RF energy is not as readily absorbed or dampened and can easily penetrate the ear). Ideally, the tag 10 of this embodiment will be applied to the upper part of the ear of the animal so that the HF RFID is presented with a view that clears the animal's head.

Third, the position of the “flag” part 14 of this construction enables visual reading of number marks or other visual indicia engraved or printed on the tag surface. Fourth, the construction retains the tag configuration close to the surface of the ear and presents a minimum of material that can be snagged or trapped by fences and equipment. This construction has the potential to improve retention of the tag 10 in the animal's ear as compared with alternative designs.

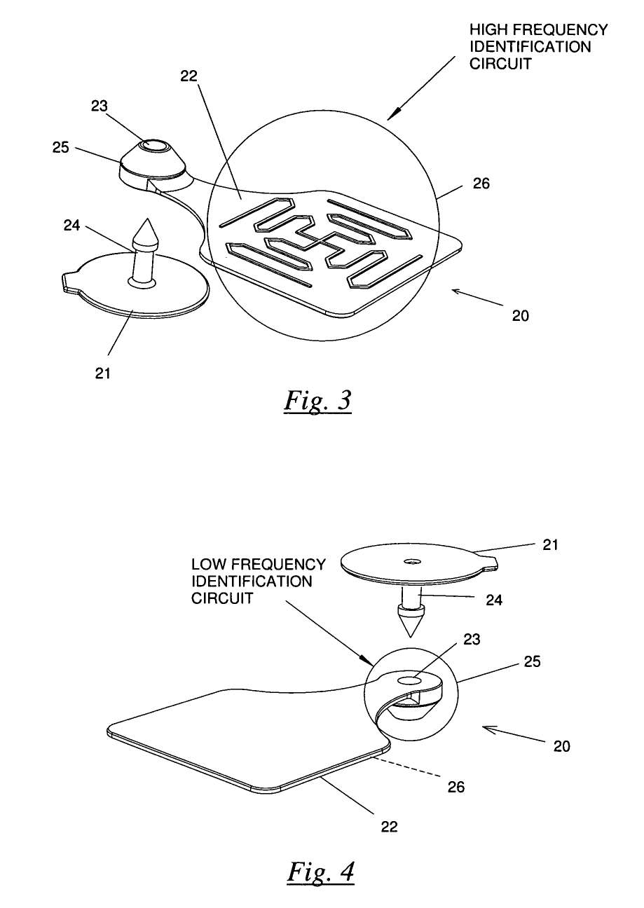

FIGS. 3 and 4 show another embodiment of the dual frequency tag 20 according to the present invention. The dual frequency tag 20 of this embodiment has a two-piece construction 21, 22 that relies upon a female part 23 and a male part 24 coupled together to attach to an animal's ear. All other features of this construction are similar to those described above for the embodiment shown in FIGS. 1 and 2. The construction of the tag 20 in this embodiment is similar to many simple visual tags used in the livestock industry. The tag 20 is attached to the ear with the LF RFID circuit 25 within the ear as described above, but with the HF RFID circuit 26 hanging below and outside of the ear fold. This construction should provide adequate RF access to the HF-RF antenna and, should provide adequate HF RFID communication in most cases. The flag part 22 of the tag 20 can also be engraved or printed with numbers or other visual indicia to allow visual identification of the animal.

The utility of a dual frequency tag according to either of the embodiments described above would be determined by the application and the antenna and reader used in the application. For applications where the RFID for a single animal or animals moving in single file can be read, then the ISO or low frequency mode would be used. For applications where a longer range reading is required, such as cattle alleyways or sale pens, then an antenna/reader combination would be chosen to operate in high frequency mode. These applications at high frequency could also utilize anti-collision technology to identify animals in a group. The dual frequency tags 10, 20 would simultaneously meet the ISO standard and be acceptable worldwide. Any ISO reading device operating at the ISO standard frequency could read the ear tag.

The use of at least two frequencies for an RFID device to enable it to meet a broader range of applications will provide a substantial improvement over the prior art by combining the benefits of both high and low frequency RFID devices. Other advantages of the present invention will be apparent to those skilled in the art upon reading this disclosure.

As explained above, the present invention uses either two RFID circuits or one combined circuit to drive two antennas, one operating at low frequency and the other at high frequency, both using a common digital sequence that includes a unique identification number for an animal. This combination is incorporated into a single functional tag so that both the LF and HF antennas are inseparably combined and carried on the same animal. The exact geometric shape, relative dimensions of their component parts, configuration of the male pin and the female locking receptacle, and the actual size of the ear tags are not critical to the present invention and can be modified without departing from the basic concepts of the present invention.

While the invention has been specifically described in connection with specific embodiments thereof, it is to be understood that this is by way of illustration and not of limitation, and the scope of the appended claims should be construed as broadly as the prior art will permit.

What is claimed is:

1. An identification system for animals, comprising:
a structure for attaching the identification system to a body part of an animal;
a first radio frequency identification component having a first antenna operating at a first frequency;
a second radio frequency identification component having a second antenna operating at a second frequency, said second frequency being higher than said first frequency; and
a means for transmitting an identification code from both of the first and second antennas for allowing the identification code to be read by readers operating at different frequencies to identify the same animal.

2. The identification system according to claim 1, wherein said structure for attaching the identification system to a body part of an animal is an ear tag that attaches to an ear of the animal.

3. The identification system according to claim 2, wherein said first radio frequency identification component is contained within a first part of the ear tag that fits within an animal's ear, and said second radio frequency identification component is contained within a second part of the ear tag located on an outside of the animal's ear.

4. The identification system according to claim 3, wherein said ear tag has a one piece construction with a flag portion adapted to be placed on an outside surface of the animal's ear, a coupling portion adapted to be placed within the animal's ear, and a flexible portion connecting the flag portion and the coupling portion.

5. The identification system according to claim 4, wherein said flag portion has a display surface on which visual indicia are displayed to allow visual identification of the animal.

6. The identification system according to claim 4, wherein said first radio frequency identification component is contained within said coupling portion, and said second radio frequency identification component is contained within said flag portion.

7. The identification system according to claim 2, wherein said first and second radio frequency identification components are molded within said ear tag.

8. The identification system according to claim 2, wherein said ear tag has a two-piece construction with a flag portion adapted to be placed on one side of an animal's ear and a coupling portion adapted to be placed on an opposite side of the animal's ear, and wherein said first and second radio frequency identification components are contained within said flag portion of the ear tag.

9. The identification system according to claim 8, wherein said flag portion has a display surface on which visual indicia are displayed to allow visual identification of the animal.

10. The identification system according to claim 1, wherein said first and second radio frequency identification components are each programmed to transmit the same identification code when interrogated by respective reading antennas.

11. The identification system according to claim 1, wherein said first frequency is approximately 134.2 kHz, and said second frequency is at least about 13.56 MHz.

12. The identification system according to claim 11, wherein said second frequency is about 868 to 915 MHz.

13. The identification system according to claim 11, wherein said second frequency is about 2.45 to 5.8 GHz.

14. A dual frequency identification system, comprising:
a first radio frequency identification component having a first antenna operating at a first frequency;
a second radio frequency identification component having a second antenna operating at a second frequency, said second frequency being at least an order of magnitude different from said first frequency; and
a programmable microchip associated with said first and second components for storing and transmitting an identification code from both of the first and second antennas so that the identification code can be read by readers operating at different frequencies.

15. A method of marking and identifying animals, comprising the steps of:
providing a tag having a radio frequency identification system with first and second antennas operating at different frequencies, and an identification code programmed into said system that can be transmitted from said first and second antennas;
attaching the tag to a body part of an animal; and
using a first reader to read the identification code transmitted from said first antenna.

16. The method according to claim 15, further comprising the step of using a second reader to read the identification code transmitted from said second antenna.

17. The method according to claim 16, wherein said radio frequency identification system is programmed to transmit the same identification code from both of said first and second antennas, whereby the tag can be read by either of said first and second readers to identify the same animal.

18. The method according to claim 15, wherein said tag is an ear tag and said attaching step comprises attaching the ear tag to an animal's ear.

19. The method according to claim 18, wherein said ear tag includes a display area, and further comprising the step of using visual indicia on said display area to allow visual identification of the animal.

20. The method according to claim 15, wherein said first and second antennas operate at respective low and high frequencies that are at least an order of magnitude different from each other.
